(19) United States
(12) Patent Application Publication
(10) Pub. No.: US 2001/0048637 A1
(43) Pub. Date: Dec. 6, 2001

(54) Microfluidic system and method

(76) Inventors: Bernhard H. Weigl, Seattle, WA (US); Ron Bardell, Redmond, WA (US)

Correspondence Address: GRAY CARY WARE & FREIDENRICH, 4365 EXECUTIVE DRIVE, SUITE 1600, SAN DIEGO, CA, 92121-2189, US

(21) Appl. No.: 09/864,745

(22) Filed: May 24, 2001

Related U.S. Application Data
(60) Provisional application No. 60/206,878, filed on May 24, 2000.
(60) Provisional application No. 60/213,865, filed on Jun. 23, 2000.
(60) Provisional application No. 60/233,396, filed on Sep. 18, 2000.

(51) Int. Cl. B01F 5/00; G01N 1/18; B01D 11/04; B01D 21/00

(52) U.S. Cl. 366/341; 210/634; 210/702; 436/178

(57) ABSTRACT

A microfluidic device and method for improved diffusion between at least two parallel-flowing fluids. A structure for a microfluidic device includes a first inlet channel, a second inlet channel, and at least one outlet channel connected to the first and second inlet channels. A measure of the first inlet channel is smaller than a measure of the second inlet channel, directing a particular cross-sectional flow in the outlet channel that avoids a “butterfly effect” of adverse diffusion. In an outlet channel having at least two fluidic inlets, the chemical or physical properties of parallel-flowing fluids are controlled for diffusion, concentration, extraction or detection of a substance among the fluids.

### STATEMENT OF RELATED APPLICATIONS

This application claims benefit from U.S. Provisional Patent Application No. 60/206,878, filed May 24, 2000, entitled Microfluidic Systems and Methods, and claims benefit from U.S. Provisional Patent Application No. 60/213,865, filed Jun. 23, 2000, also entitled Microfluidic Systems and Methods, and claims benefit from U.S. Provisional Patent Application No. 60/233,396, filed Sep. 18, 2000, also entitled Microfluidic Systems and Methods.

This invention relates to “Sheath Flow Assembly,” U.S. patent application Ser. No. 09/428,807, filed Oct. 28, 1999, the contents of which are incorporated by reference herein for all purposes.

### BACKGROUND OF THE INVENTION

The present invention generally relates to microfluidic systems, and in particular to a device and method for minimizing adverse flow effects in a microfluidic platform, and to a device and method for concentrating, extracting or separating a substance in a microfluidic structure.

Using tools and fabrication techniques developed by the semiconductor industry to miniaturize electronics, it has become possible to fabricate intricate fluid systems which can be inexpensively mass produced. Microfluidic systems have been developed to exploit physical properties and flow characteristics of fluids within micro-sized channels, for various analytical techniques. Brody et al., U.S. Pat. No 5,922,210, describe several examples of such microfluidic devices.

FIG. 1 is a three dimensional view of a section 100 of a microfluidic device, such as an H-filter as described in Yager et al., U.S. Pat. No. 5,932,100, for example. The section 100 includes a first inlet channel 110 for carrying a first fluid stream A and a second inlet channel 120 for carrying a second fluid stream B. The first and second streams A and B flow in contact with each other in an outlet channel 130, separated by an interface 132. The interface 132 represents a dividing line between the streams A and B, which due to diffusion and other forces will change with respect to time and distance in the outlet channel 130. Along the direction of flow of the fluid streams, a diffusion region 134 forms, in which a component of one fluid stream diffuses into the other fluid stream. While each fluid experiences diffusion by a component of the other fluid, for simplicity only diffusion of a component from the first fluid into the second fluid is discussed with reference to FIG. 1.

In a typical H-filter design, the dimension of the outlet channel 130 parallel to the interface 132 is much larger than the dimension of the outlet channel 130 normal to the interface 132. Further, the widths of the first and second inlet channels 110, 120 are usually the same, and generally equal to the width of the outlet channel 130.

When multiple streams of different fluids are provided in one channel, the extent of diffusion of each chemical species from one stream to another is greater wherever the fluid velocity is lower. For example, a fluid's velocity is lower near the walls of a channel than in the center of the channel. Thus, diffusion has a greater effect nearer the walls the outlet channel 130, causing a larger diffusion region 134 approaching the channel walls and in the direction of the combined fluid flow. The appearance of the shape formed by the diffusion region 134 is referred to as the “butterfly effect.” The diffusion caused by the “butterfly effect” encroaches on the pure fluid stream B, and decreases the cross-sectional area of stream B which is harvestable downstream.

Diffusion from one fluid to another is a useful characteristic of micro-flowing fluids. Conventional microfluidic systems, however, do not adequately provide the optimal environment for diffusion to efficiently occur among fluids. Accordingly, a device and method are needed that provides efficient diffusion for use in a concentrator or extractor, or for separation and detection of a dissolved substance.

### BRIEF DESCRIPTION OF THE DRAWING

FIG. 1 illustrates a portion of a typical “H Filter” microfluidic device.

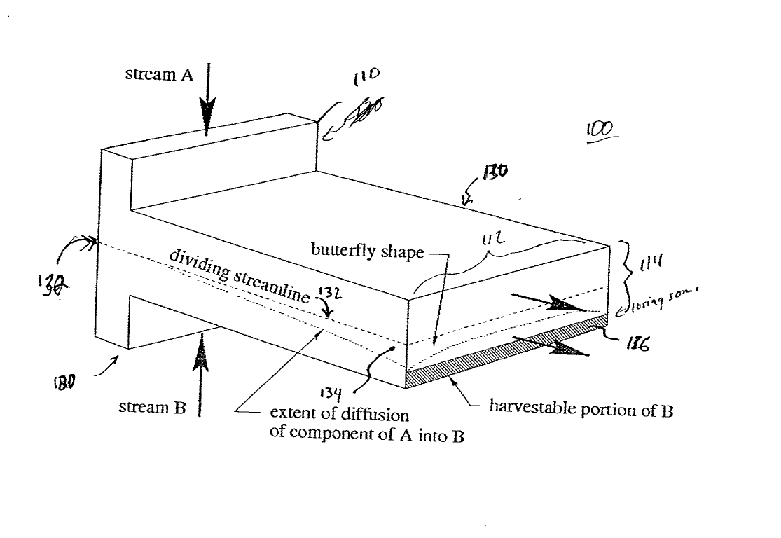

FIG. 2 shows a microfluidic structure as a portion of a microfluidic device according to one embodiment of the invention.

FIG. 3 shows a microfluidic device using different affinities of different fluids to a substance.

FIG. 4 shows a cross-section of a microfluidic device for maximizing the interface area between two fluids that flow in contact with each other.

FIG. 5 shows a side plan view of a microfluidic device using parallel flows of non-miscible fluids for extraction.

### DETAILED DESCRIPTION OF THE PREFERRED EMBODIMENTS

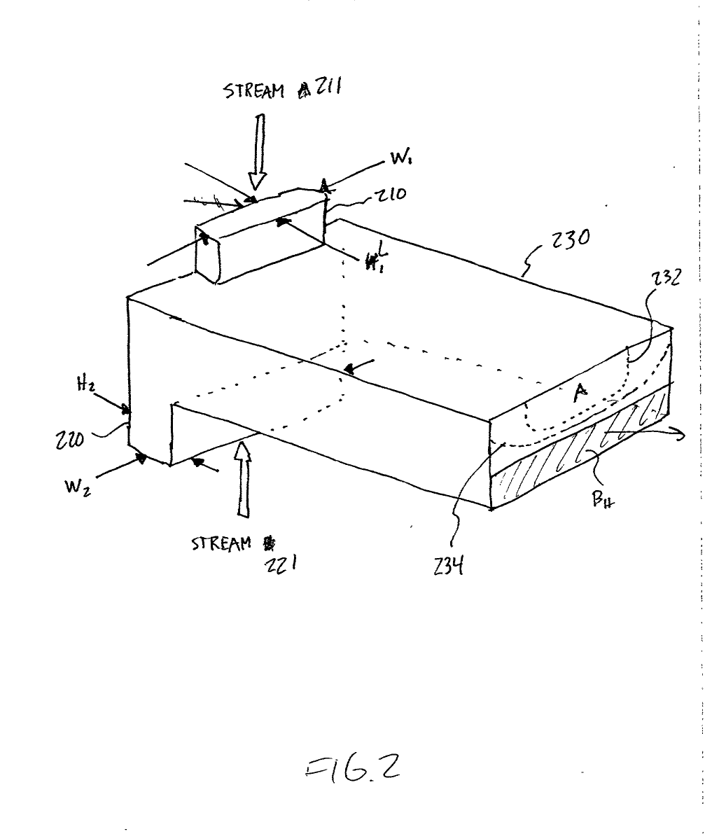

With reference to FIG. 2, there is shown a microfluidic structure 200 that overcomes the “butterfly effect” mentioned above. Microfluidic structure 200 includes first inlet channel 210 for providing a first fluid 211, a second inlet channel 220 for providing a second fluid 221, and an outlet channel 230 in which the first and second fluid flow in contact with each other, in an aggregate fluid stream.

As illustrated in FIG. 2, the aggregate fluid stream includes the first fluid 211 and the second fluid 221 separated by a fluid interface 232. The second fluid 221 at least partially surrounds the first fluid 211. Preferably, the second fluid 221 surrounds the first fluid 211 on three sides, as the first fluid 211 is provided by the first inlet channel 210 such that it avoids two side wall regions of the outlet channel 230. A diffusion boundary 234 defines the extent of diffusion of a component in fluid 211 into fluid 221, thereby defining a portion B_{H} of fluid 221 that is harvestable from the outlet channel 230, undiluted with any component from fluid 211.

In accordance with the invention, a measure of the first inlet channel 210 is smaller than a measure of the second inlet channel 220. The measure includes, without limitation, any dimension, capacity, or amount of something ascertainable by measuring. For instance, one measure of the first inlet channel 210 includes a cross-sectional area, defined by a width W₁ and a length L₁. The corresponding measure of the second inlet channel 220 includes a cross-sectional area defined by a width W₂ and a length L₁. According to the invention, at least one measure of the first inlet channel 210 is less than a measure of the second inlet channel 220. In one embodiment, the width W₁ of the first inlet channel 210 is less than the corresponding width W₂ of the second inlet channel 220. In another embodiment, the length L₁ of the first inlet channel 210 is less than the corresponding length L₂ of the second inlet channel. In yet another embodiment, the cross-sectional area of the first fluid stream A defined by the first inlet channel 210 is less than the cross-sectional area of the second fluid stream B defined by the second inlet channel 220. Alternatively, volume or rate of flow of the fluid is used as a measure.

The second inlet channel 220 and the outlet channel 230 can be constructed as a unitary microfluidic channel structure, and the first inlet channel 210 is connected to the structure as an alternate inlet channel for providing a fluid stream. In this embodiment, the inlet channel 220 and the outlet channel 230 can have substantially the same width measure. A cross-sectional dimension of the alternate inlet channel is sized and shaped such that the fluid stream it provides to the outlet channel 230 avoids opposing sidewalls of the outlet channel 230, and is at least partially surrounded by fluid stream provided by the second inlet channel 220.

Each channel of the microfluidic structure 200 is illustrated in FIG. 2 as having a substantially square cross section and being substantially straight. However, the cross section of a channel can be any shape, including rounded or flat. Moreover, each channel can include one or more bends, rather than being straight. Thus, the cross-sectional shape and linearity of any channel of the microfluidic structure 200 should not be limited to any particular cross-section or linearity.

Fluids that flow adjacently will usually exhibit some diffusion of a substance from one fluid to another. Depending on the chemical compositions of each fluid, this diffusion can be used to form a number of useful devices, including a concentrator, a separator, an extractor, or a flow-cytometer, among other devices.

The extent and degree of diffusion between adjacently flowing fluids depends at least in part on the fluids miscibility to each other. Miscible fluids will tend to form a single phase when flowing next to each other. Non-miscible fluids always form separate phases when flowing next to each other. Generally, non-miscible fluids will form droplets of one fluid within another, separated by density or emulsions. However, even for non-miscible fluids, a certain percentage of each fluid can be miscible with another fluid. In between these two extremes, “borderline” or marginally-miscible fluids can form a single phase, but tend to minimize their contact area, which in a microchannel typically produces droplets.

Other factors affecting diffusion include a difference of affinity to a substance exhibited by two or more miscible adjacent streams, the relative speed of adjacent miscible streams, a change in conformation and/or size of dissolved molecules as they diffuse, and degree of precipitation and/or re-suspension in a smaller volume. Still another factor is the contact interface between adjacent fluids. For example, a concentric flowing of two fluids provides a large contact area for diffusion to occur. Or, a concentric injection of droplets into a non-miscible stream can be used to maximize the interface area between two fluids.

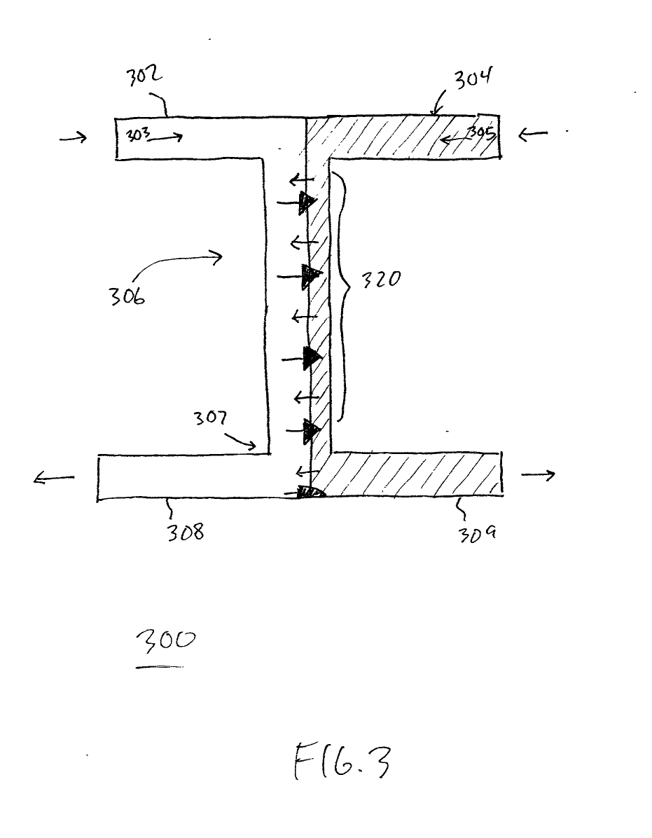

FIG. 3 shows a microfluidic device 300 based on different affinities of different fluids to a substance. Microfluidic device 300 is shown as an H-Filter-type structure, having a first inlet 302 providing a first fluid 303, a second inlet 304 providing a second fluid 305, and a channel 306 in which the first and second fluids 303 and 305 flow in contact. The channel has at least one outlet 307, which can branch out to multiple outlets, such as shown with reference to 308 and 309. More than two inlets are also possible, providing three or more parallel fluid streams, and the channel 306 can include any number of surface walls for channeling or directing the fluid streams. The channel 306 contains a transition region 320, in which diffusion-based extraction, separation, or concentration occurs between the adjacently flowing fluid streams.

The size of the transition region 320 will vary depending on many factors. For example, a longer channel 306 will lead to a larger transition region. Furthermore, the sidewalls of the channel 306 may be treated with a coating, such as a hydrophilic treatment for aqueous solutions or a hydrophobic treatment for non-aqueous solutions. Such coatings will affect the flow rates through the channel. The channel 306 can contain channeling walls or other structural elements to increase or minimize the surface tension of the fluids.

At least one of the two fluids provided by the first inlet 302 or second inlet 304 contains a substance to be concentrated. The fluids are adapted to have a different affinity to the substance, the existence of which provides the basis for diffusion and concentration of the substance into one of the two fluids. In one exemplary embodiment, the first fluid 303 contains the substance to be concentrated, and the second fluid 305 includes an extraction solvent having a higher affinity to the substance than the first fluid. The substance will preferential diffuse to, or concentrate within, the extraction solvent of the second fluid 305, thereby forming a higher concentration of the substance in the second fluid 305.

The substance can be concentrated in a smaller volume than which it was previously dissolved by reducing the width or volume of the second fluid stream in the transition region 320. The width or volume can be reduced by reducing the pressure from the second inlet, or by reducing the cross-sectional area of the second inlet. The principles of this invention can be used to form an extraction device. The concentration of a substance in a sample within one of the fluids is reduced by diffusing into the other fluid.

The concentration of a substance in, or extraction of a substance from, one of two or more fluids is based on different affinities of the fluids to the substance or substances. In one example, certain fluid compositions are used whereby one fluid provides a higher solubility for the substance than another fluid. In another example, the substance can be temporarily or permanently attached to other particles contained in one fluid.

The difference in affinity to the substance among the fluids used can also arise from at least one of the following: temporary or permanent attachment of the substance to be concentrated or extracted to particles or surfaces contained on walls in the channel 306, or walls that are adjacent to the higher-affinity fluid; a change in size of molecules of the substance as it conforms to the higher-affinity fluid and diffuses therein; temporary or permanent attachment of the substance to solvent molecules in the higher-affinity fluid, which thereby increases the size of the molecules of the substance; and temporary or permanent precipitation of the substance as molecules of the substance diffuse out of one fluid into another.

Other affinity differences are based on differences in viscosity or temperature between the fluids, or other differences in other properties affecting the diffusion coefficient of the substance to the respective fluids. These property differences include pH differences between the fluids, differences in chemical composition, and differences in a concentration of dissolved particles affecting diffusion.

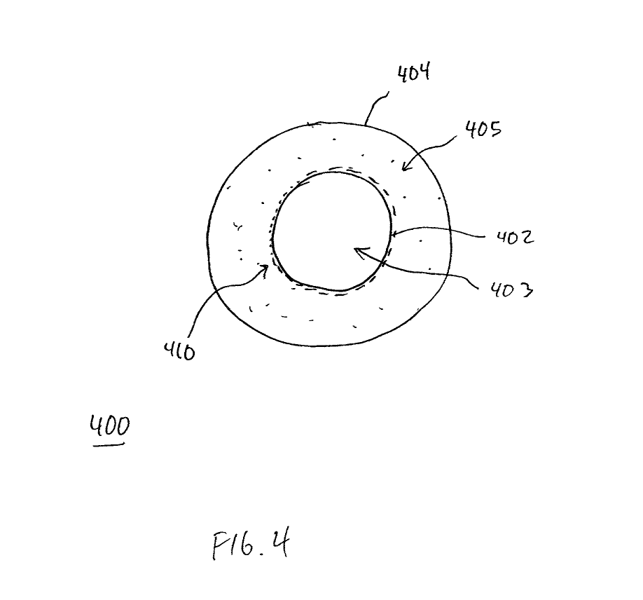

FIG. 4 shows a cross-section of a microfluidic device 400 that forms a concentrator or separator based on maximizing the interface area between two fluids. A first channel 402 and a second channel 404 are concentrically disposed. In one embodiment, the first channel 402 is contained within a concentric second channel 404. The first channel 402 provides a first fluid 403 and the second channel 404 provides a second fluid 405. The first channel 402 and second channel 404 are preferably coupled to a common outlet in which the first fluid 403 and second fluid 404 continue flowing concentrically, whereby the second fluid stream forms a sheath flow around the first fluid stream.

This arrangement for microfluidic device 400 maximizes the area of the diffusion interface 410, to increase the extraction and/or concentration efficiency. In one embodiment, the first fluid 403 is a sample stream which is injected into the sheath flow of the second fluid 405, which forms an extraction stream. Diffusion occurs at the interface 410 between the first fluid 403 and the second fluid 405. As in the case of the device 300 described with reference to FIG. 3, the microfluidic device 400 can be used with fully miscible and borderline miscible fluids, and can use a difference in affinity between the fluids to a dissolved substance.

In an alternative embodiment of device 400, a third fluid is injected in between two concentric sheath layers comprised of the first and second fluids, to further maximize the interface area and maximize diffusions efficiency. The first and second fluids can have similar compositions, or dissimilar compositions. Additional numbers of concentric flows of fluid are possible within the scope of this invention.

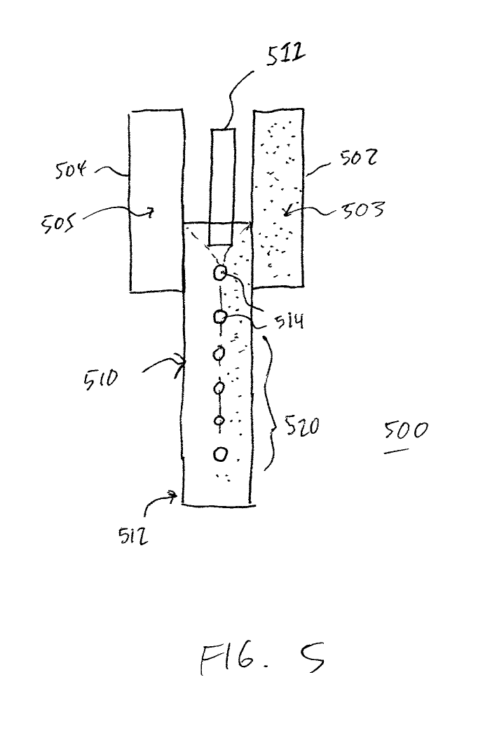

FIG. 5 shows a side plan view of a microfluidic device 500 using parallel flows of non-miscible fluids for extraction. The microfluidic device 500 includes a microfluidic structure 510 having at least one inlet 502 and at least one outlet 512, wherein one of the at least one inlets is configured to provide a first fluid 503 containing the substance to be concentrated. The microfluidic device 500 can also include a second inlet 504 providing a fluid 505 that is substantially identical to the first fluid 503, or different. An injector 511 is provided in contact with the structure 510 and is configured to inject a second fluid 514 into the first fluid 503, where the second fluid 514 is substantially immiscible with the first fluid 503.

Since the first and second fluids are immiscible, they will form different phases within the microfluidic structure 510. Within a transition region 520 in the structure 510, the first fluid and the second fluid flow in contact for an amount of time to allow at least partial extraction of a dissolved substance from the first fluid 503, which accordingly concentrates in the second fluid 514. Using a phase separator or other collection mechanism, the second fluid 514 is separated from the first fluid 503 and the concentrated substance can be detected and extracted.

In one embodiment, the second fluid 514 forms a constant stream within the first fluid 503. The second fluid 514 can also form droplets, either in single- or multiple-file, or as an emulsion. The extraction process can take place between the droplets, then separated from the first fluid 503 using flow filters or the like, or focussed in a single-file suing a sheath flow assembly, then ejected into a settling chamber. Alternatively, a flow cytometer can be used to detect substances extracted into these droplets as they are carried past a detector in single-file. It is also possible to use more than one type of solvent at a time. Furthermore, the droplets 514 may contain reagents and/or markers for additional reaction and identification.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A microfluidic structure, comprising:
a first inlet channel;
a second inlet channel; and
at least one outlet channel connected to the first and second inlet channels,
wherein a measure of the first inlet channel is smaller than a corresponding measure of the second inlet channel.

2. The structure of claim 1, wherein the measure is a cross-sectional dimension.

3. The structure of claim 2, wherein the first inlet channel is configured to provide a first fluid, the second inlet channel is configured to provide a second fluid, and the outlet channel is configured to aggregate the first and second fluids into adjacent streams.

4. The structure of claim 2, wherein at least one cross-sectional dimension of the second inlet channel is substantially equal to a corresponding cross-sectional dimension of the outlet channel.

5. The structure of claim 1, wherein the first and second inlet channels are connected to opposing sides of the outlet channel.

6. The structure of claim 5, wherein a flow direction of a fluid stream from the first and second inlet channels is substantially normal to a flow direction of a aggregate fluid stream in the outlet channel.

7. The structure of claim 3, wherein the aggregate fluid stream includes an interface at which the first fluid and the second fluid flow in parallel.

8. The structure of claim 7, wherein, in the aggregate fluid stream at the interface, the first fluid stream is contained at least partially within the second fluid stream.

9. The structure of claim 1, wherein the measure is the cross-sectional area.

10. The structure of claim 1, wherein the measure of the first inlet channel is smaller than a corresponding measure of the outlet channel.

11. A fluid aggregation device, comprising:
a microfluidic channel having an inlet and an outlet; and
at least one additional inlet channel connected to the microfluidic channel, and having a measure that is less than a corresponding measure of the inlet of the microfluidic channel.

12. The device of claim 11, wherein the measure is a cross-sectional dimension.

13. The device of claim 11, wherein the measure is cross-sectional area.

14. The device of claim 11, wherein the measure of the at least one additional inlet channel is less than a corresponding measure of the outlet of the microfluidic channel.

15. The device of claim 11, wherein the inlet of the microfluidic channel is configured to provide a first fluid stream, and the at least one additional inlet channel is configured to provide a second fluid stream.

16. The device of claim 15, wherein the outlet of the microfluidic channel is configured to carry an aggregate fluid stream comprising the first fluid stream and the second fluid stream.

17. The device of claim 16, wherein the aggregate fluid stream comprises the first fluid stream at least partially surrounding the second fluid stream.

18. A method of aggregating fluid streams in a microfluidic channel, comprising:
providing a first fluid stream to an outlet channel; and
providing a second fluid stream to the outlet channel concurrently with the first fluid stream, wherein a measure of the second fluid stream is arranged to be less than a corresponding measure of the first fluid stream.

19. The method of claim 18, further comprising providing an aggregate fluid stream in the outlet channel.

20. The method of claim 19, wherein the aggregate fluid stream comprises the first fluid stream at least partially surrounding the second fluid stream.

21. A microfluidic device for concentrating a dissolved substance, comprising:
a microfluidic structure having at least two inlets and at least one outlet; and
a transition region in the structure in which a first fluid containing at least a portion of the dissolved substance, and a second fluid having a different affinity to the substance than the first fluid, flow in contact with each other, thereby allowing accumulation of the substance in the second fluid.

22. The device of claim 21, wherein a first inlet is configured to provide the first fluid, the second inlet is configured to provide the second fluid, and the outlet forms a channel.

23. The device of claim 21 wherein the dissolved substance is extracted from the first fluid within the transition region.

24. The device of claim 21, wherein the second fluid has a higher affinity to the substance than the first fluid.

25. The device of claim 21, wherein the first fluid and the second fluid flow adjacently in contact with each other.

26. The device of claim 21, wherein the first fluid and the second fluid flow concentrically in contact with each other.

27. The device of claim 21, wherein the affinity difference is based on a solubility of the substance to the first and second fluids.

28. The device of claim 21, wherein the second fluid contains particles to which the substance is attracted.

29. The device of claim 21, wherein the structure includes at least one channel wall.

30. The device of claim 29, wherein the channel wall contains particles to which the substance attracted.

31. The device of claim 21, wherein the affinity difference is based on a conformance by the second fluid to a size change of the substance as it diffuses into the second fluid.

32. The device of claim 31, wherein the second fluid includes solvent molecules configured to establish the conformance.

33. The device of claim 31, wherein the size change of the substance includes a precipitation of the substance.

34. The device of claim 21, wherein the second fluid has a higher viscosity than the first fluid.

35. The device of claim 21, wherein the second fluid has a higher temperature than the first fluid.

36. The device of claim 21, wherein the second fluid has a different pH level than the first fluid.

37. The device of claim 21, wherein the second fluid has a different chemical composition than the first fluid.

38. The device of claim 21, wherein the second fluid has a different concentration of dissolved particles than the first fluid.

39. The device of claim 21 wherein the second fluid has less volume than the first fluid in the transition region.

40. The device of claim 21, wherein a cross-sectional area of a first inlet is greater than a cross-sectional area of a second inlet.

41. The device of claim 21, wherein a rate of flow of the second fluid is less than a rate of flow of the first fluid.

42. A microfluidic device for concentrating a dissolved substance, comprising:
a microfluidic structure having at least one inlet and at least one outlet; and
a precipitation region within the structure configured to induce a precipitation of the substance in a fluid containing the dissolved substance.

43. The device of claim 42, wherein the microfluidic structure includes a first inlet for providing a first fluid and a second inlet for providing a second fluid, and wherein the precipitation region is configured to resuspend the substance in a smaller volume of a the second fluid.

44. The device of claim 43, wherein the second fluid has a greater affinity for the substance than the first fluid.

45. A microfluidic device for concentrating a dissolved substance, comprising:
a microfluidic structure having at least one inlet and at least one outlet, wherein one of the at least one inlets is configured to provide a first fluid containing the substance to be concentrated;
an injector in contact with the structure configured to inject a second fluid into the first fluid, wherein the second fluid is substantially immiscible with the first fluid; and
a transition region in the structure in which the first fluid and the second fluid flow in contact for an amount of time to allow at least partial extraction of the substance from the first fluid and concentration of the substance in the second fluid.

46. The device of claim 45, wherein the injector is configured to provide the second fluid as a stream.

47. The device of claim 45, wherein the injector is configured to provide the second fluid as a plurality of droplets.

48. The device of claim 47, further comprising a collector configured to separate and collect the droplets.

49. The device of claim 47, further comprising a detector configured to detect the presence and/or concentration of the concentrated substance.

50. The device of claim 49, wherein the detector is a flow cytometer.

51. The device of claim 48, wherein the collector is a phase separator for separating the immiscible first and second fluids.

52. A method contacting multiple streams in a microfluidic structure, comprising:
providing a first fluid into the structure; and
providing a second fluid into the structure, wherein a volume of the second fluid is greater than a volume of the first fluid such that the second fluid at least partially surrounds the first fluid as they flow in contact with each other.

53. The method of claim 52, wherein providing the first fluid further includes limiting a cross-sectional area of the first fluid flow.

54. A method of concentrating a dissolved substance, comprising:
providing a first fluid into a microfluidic structure, wherein the first fluid contains at least a portion of the dissolved substance; and
providing a second fluid into the microfluidic structure such that the second fluid flows in contact with the first fluid within the structure, wherein the second fluid has a different affinity to the substance than the first fluid to allow accumulation of the substance in the second fluid.

55. The method of claim 54, wherein the second fluid has a higher affinity to the substance than the first fluid.

56. The method of claim 54, wherein providing the second fluid further includes flowing the second fluid concentrically with the first fluid.

57. The method of claim 54, wherein providing the second fluid further includes flowing the second fluid adjacently in parallel with the first fluid.

58. The method of claim 54, wherein the affinity difference is based on a solubility of the substance to the first and second fluids.

59. The method of claim 54, wherein the second fluid contains particles to which the substance is attracted.

60. The method of claim 54, wherein the microfluidic structure includes at least one channel wall proximate the flow of the second fluid, and the channel wall contains particles to which the substance is attracted.

61. The method of claim 54, wherein the affinity difference is based on a conformance by the second fluid to a size change of the substance as it diffuses into the second fluid.

62. The method of claim 54, wherein the second fluid includes solvent molecules configured to establish the conformance.

63. The method of claim 54, wherein the size change of the substance includes a precipitation of the substance.

64. The method of claim 54, wherein the second fluid has a higher viscosity than the first fluid.

65. The method of claim 54, wherein the second fluid has a higher temperature than the first fluid.

66. The method of claim 54, wherein the second fluid has a different pH level than the first fluid.

67. The method of claim 54, wherein the second fluids has a different chemical composition than the first fluid.

68. The method of claim 54, wherein the second fluids has a different concentration of dissolved particles than the first fluid.

69. The method of claim 54, wherein the second fluid has less volume than the first fluid.

70. The method of claim 54, wherein the second fluid is provided at a smaller cross-sectional area than the first fluid.

71. The method of claim 54, wherein the second fluid is provided at a lower a rate of flow than the first fluid.

72. A method of extracting a dissolved substance, comprising:
providing a first fluid into a microfluidic structure, wherein the first fluid contains at least a portion of the dissolved substance; and
injecting a second fluid into the first fluid within the microfluidic structure such that the second fluid flows in contact with the first fluid, wherein the second fluid is immiscible with the first fluid to allow for phase separation between the first and second fluids, the interface at which the substance diffuses from the first fluid into the second fluid.

73. The method of claim 72, further comprising detecting the phase separation at an outlet of the microfluidic structure.

74. The method of claim 72, further comprising collecting the second fluid at an outlet of the microfluidic structure.

75. The method of claim 72, wherein injecting the second fluid into the first fluid includes forming a stream of the second fluid within the first fluid.

76. The method of claim 75, wherein the first fluid concentrically surrounds the stream of the second fluid.

77. The method of claim 72, wherein injecting the second fluid into the first fluid includes forming droplets of the second fluid within the first fluid.

78. The method of claim 77, wherein the droplets are formed in a single-file.

79. The method of claim 77, wherein the droplets are formed in multiple-files.

80. The method of claim 72, wherein the second fluid has a higher affinity to the substance than the first fluid.
